(19) United States
(12) Patent Application Publication
(10) Pub. No.: US 2026/0075312 A1
(43) Pub. Date: Mar. 12, 2026

(54) INFORMATION PROCESSING APPARATUS DISPLAYING MIXED REALITY, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: MAIKI OKUWAKI, Kanagawa (JP)

(21) Appl. No.: 19/309,025

(22) Filed: Aug. 25, 2025

(30) Foreign Application Priority Data
Sep. 6, 2024 (JP) 2024-153864

(51) Int. Cl. H04N 23/65; G02B 27/01; H04N 23/667

(52) U.S. Cl. CPC H04N 23/651; G02B 27/017; H04N 23/667

(57) ABSTRACT

An information processing apparatus capable of adaptively reducing power consumption. The information processing apparatus includes a memory device that stores a set of instructions, and at least one processor that executes the set of instructions to obtain a region of a virtual space to be displayed on a display unit in a manner superimposed on a real space captured by a first camera as a display region, and switch a drive mode of the first camera according to a size of the display region.

### BACKGROUND

### Field of the Technology

The aspect of the embodiments relates to an information processing apparatus displaying mixed reality, control method therefor, and storage medium storing control program therefor.

### Description of the Related Art

In recent years, accuracy of a head mounted display (hereinafter referred to as an “HMD”) that allows a user to experience a mixed reality (hereinafter referred to as an “MR”) has been improved. Accordingly, a camera that captures an image of a real space (hereinafter referred to as a “real space image”) displayed as a background image of the MR operates at a high frame rate and high resolution. Therefore, the HMD consumes more electric power because it processes a real space image with a high frame rate and high resolution. Therefore, in order for a user to use a stand-alone HMD equipped with a mobile battery for a long time, a mechanism to reduce a power consumption is required.

As a mechanism to reduce a power consumption, for example, it is conceivable to cause the camera to lower the frame rate or the resolution when capturing a real space image. However, since the MR displays an image of a virtual space (hereinafter, referred to as a “virtual space image”) to be superimposed on a background image, the reduction of quality of a background image due to the reduction of the frame rate or the resolution of the camera deteriorates quality of the user experience. On the other hand, Japanese Patent Laid-Open No. 2012-212989 (JP 2012-212989A) discloses, as another mechanism for reducing power consumption, a technique of controlling a camera mounted on an HMD to reduce power consumption when an image capturing direction of the camera deviates from a predetermined angular range.

However, a user who is experiencing the MR with the HMD may not only view various directions but also freely change a display mode of an MR image. In this case, if the power saving control is performed at the predetermined angular range as in the technique disclosed in the above publication, there is a problem that it is difficult to achieve the power saving suitable for the display mode of the MR image.

### SUMMARY

The present disclosure provides an information processing apparatus capable of adaptively reducing power consumption, a control method therefor, and a storage medium storing a control program therefor.

Accordingly, an aspect of the embodiments provides an information processing apparatus including a memory device that stores a set of instructions, and at least one processor that executes the set of instructions to obtain a region of a virtual space to be displayed on a display unit in a manner superimposed on a real space captured by a first camera as a display region, and switch a drive mode of the first camera according to a size of the display region.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of an information processing apparatus of a first embodiment.

FIG. 2 is a block diagram illustrating an example of a software logical configuration of the information processing apparatus of the first embodiment.

FIG. 3 is a flowchart illustrating a process performed when a drive mode of a background camera is switched in the first embodiment.

FIG. 4A and FIG. 4B are views for describing a relationship between a virtual-space display region and switching of the drive mode of the background camera in the first embodiment.

FIG. 5A and FIG. 5B are views illustrating a pop-up and icons for notifying a user that the background camera is in a power saving state in the first embodiment.

FIG. 6 is a view illustrating a user interface (referred to as a “UI”) screen for a user to instruct setting change of a preset size of the virtual-space display region in the first embodiment.

FIG. 7 is a block diagram illustrating an example of a software logical configuration of an information processing apparatus of a second embodiment.

FIG. 8 is a flowchart illustrating a process performed when a drive mode of a background camera is switched in the second embodiment.

FIG. 9A and FIG. 9B are views for describing a relationship between a virtual-space display region and switching of the drive mode of the background camera in the second embodiment.

FIG. 10 is a view illustrating a UI screen for a user to instruct setting change of a preset first transparency and setting change of a preset pixel number in the second embodiment.

FIG. 11 is a block diagram illustrating an example of a software logical configuration of an information processing apparatus of a third embodiment.

FIG. 12 is a flowchart illustrating a process performed when a drive mode of a background camera is switched in the third embodiment.

FIG. 13 is a view illustrating a situation in which a hand of a user overlaps a virtual space in a case where the background camera operates in the power saving mode in the third embodiment, from a viewpoint of looking down from above the user.

FIG. 14 is a view illustrating one of specific display examples of a person other than the user in the third embodiment.

### DESCRIPTION OF THE EMBODIMENTS

Hereinafter, embodiments of the present disclosure will be described in detail with reference to the attached drawings. However, the configurations described in the following embodiments are merely examples, and the scope of the present disclosure is not limited by the configurations described in the embodiments. For example, each of the units constituting the present disclosure can be replaced with any unit that can exhibit the same function. In addition, an arbitrary constituent may be added. Any two or more configurations (features) of the embodiments can be combined. In addition, all combinations of features described in each embodiment are not necessarily essential to the solution of the present disclosure. In addition, the features of each embodiment can be modified or changed as appropriate depending on the specifications of the apparatus to which the present disclosure is applied and various conditions (use conditions, use environment, etc.).

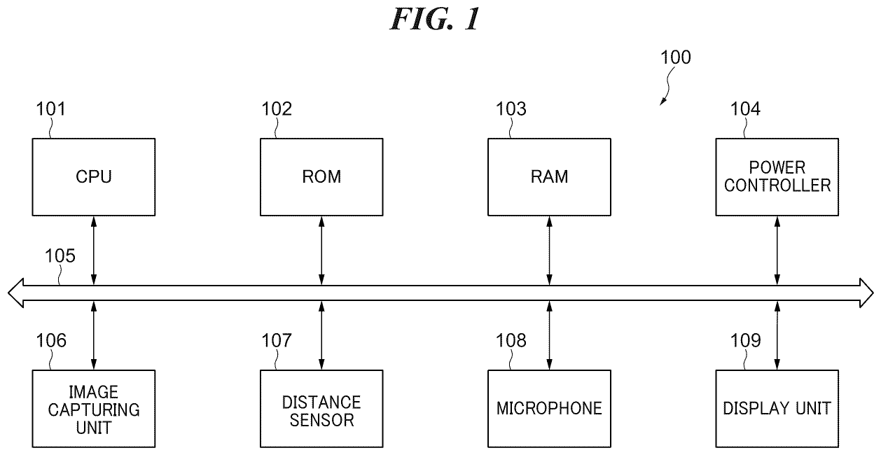

Hereinafter, a first embodiment will be described with reference to FIG. 1 through FIG. 6. FIG. 1 is a block diagram illustrating an example of a hardware configuration of an information processing apparatus 100 of the first embodiment. As illustrated in FIG. 1, the information processing apparatus 100 includes a CPU 101, a ROM 102, a RAM 103, a power controller 104, a bus 105, an image capturing unit 106, a distance sensor 107, a microphone 108, and a display unit 109. In the information processing apparatus 100, these hardware configuration components (except for the bus 105) are connected to the bus 105 so that they can exchange data with each other. The CPU 101 is an arithmetic device that comprehensively controls the information processing apparatus 100, and executes various programs stored in the ROM 102 to perform various processes.

The ROM 102 is a read-only nonvolatile memory device, and stores the various program and parameters that do not need to be changed. The RAM 103 is a memory device that provides a work area to the CPU 101, and temporarily stores input information from various devices, operation results in an image process, etc. For example, a real space image, a rendered virtual space image, and data of a position and an orientation of an HMD (described later) are stored in the RAM 103. The power controller 104 is connected to a power supply that supplies power to the image capturing unit 106 and the like of the information processing apparatus 100, controls supply of driving power, and manages a remaining power capacity.

The image capturing unit 106 includes imaging capturing devices built in the information processing apparatus 100. The image capturing devices include a background camera (a first camera) for displaying a background of an MR image, and a position camera (a second camera) for estimating a position and an orientation of a hand of a user (described later). The distance sensor 107 (a third camera) is capable of measuring a distance. The distance sensor 107 may be a LiDAR or a TOF sensor. The microphone 108 collects sound around the information processing apparatus 100. The display unit 109 is capable of displaying an MR image, a VR image, etc.

The information processing apparatus 100 having the above-described hardware configuration components is incorporated in a goggle type or an eyeglasses type HMD of a video see through system to be worn on a head of a user. The information processing apparatus 100 may be incorporated in, for example, a smartphone, a tablet, a digital camera, or the like, other than the HMD. The information processing apparatus 100 including the CPU 101, the ROM 102, and the RAM 103 may be connected to the HMD including the power controller 104, the image capturing unit 106, the distance sensor 107, the microphone 108, and the display unit 109 to constitute an information processing system.

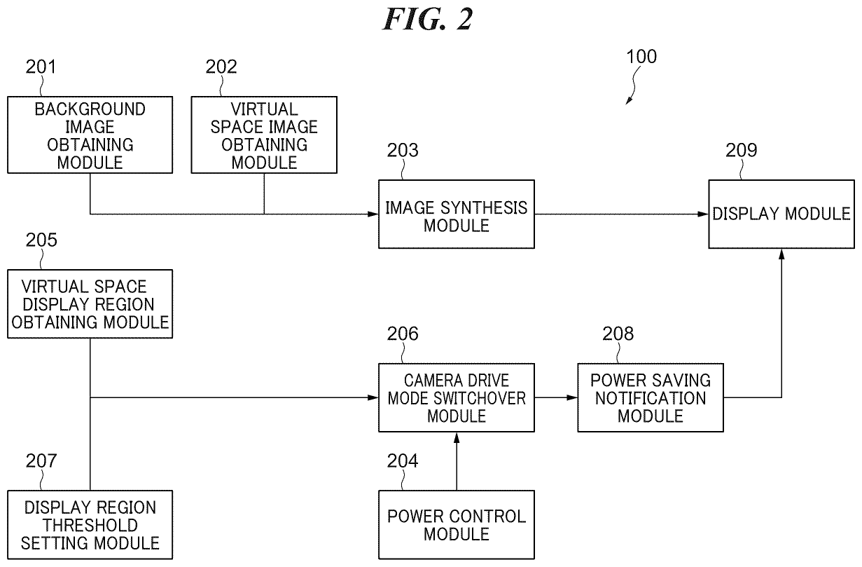

FIG. 2 is a block diagram illustrating an example of a software logical configuration of the information processing apparatus 100 of the first embodiment. A background image obtaining module 201 obtains a real space image from the background camera of the image capturing unit 106 as an MR background image. A virtual space image obtaining module 202 obtains a virtual space image in which a CG object in a virtual space is rendered. An image synthesis module 203 synthesizes the background image obtained from the background image obtaining module 201 and the virtual space image obtained from the virtual space image obtaining unit 202 to obtain a synthetic image. A power control module 204 supplies driving power and notifies a camera drive mode switchover module 206, which will be described later, of a remaining power capacity.

A virtual space display region obtaining module 205 (a first obtaining unit) obtains a region of the virtual space (hereinafter referred to as a “virtual space display region”) (a display range) currently displayed on the display unit 109. The virtual-space display region may be a region in a three dimensional space occupied by a virtual space or may be a region in a two dimensional space occupied by an opaque region of a virtual space image. The virtual space display region obtaining module 205 may obtain the virtual space display region from a current display mode of a virtual space image. The camera drive mode switchover module 206 compares the size of the virtual space display region obtained from the virtual space display region obtaining module 205 with a preset size (a second threshold, a display region threshold) to determine whether the drive mode of the background camera needs to be switched. At this time, the camera drive mode switchover module 206 may determine the size of the display region of the virtual space from surface area or volume of the three dimensional virtual space, a surface area ratio or a volume ratio between the virtual space and the real space, or the number of pixels (hereinafter referred to as a “pixel number”) of the opaque region of the virtual space image. When determining that the drive mode of the background camera needs to be switched, the camera drive mode switchover module 206 instructs the background camera to switch the drive mode.

A display region threshold setting module 207 (a second setting change unit) changes the preset size of the virtual space used by the camera drive mode switchover module 206 in accordance with a user's instruction through a UI screen. When the camera drive mode switchover module 206 switches the drive mode of the background camera to a power saving mode, a power saving notification module 208 generates notification information indicating the switching. The power saving mode will be described in detail later. The display module 209 displays a synthetic image obtained from the image synthesis module 203 on the display unit 109 as an MR image. The display module 209 further displays the notification information obtained from the power saving notification module 208 on the display unit 109 by a pop-up or an icon. Thus, a user is notified that the background camera is operating in the power saving mode (hereinafter referred to as a “power saving state”). The power saving notification module 208 may notify the user of the power saving state by a method such as lighting, blinking, or voice, instead of displaying the pop-up or the icon by the display module 209.

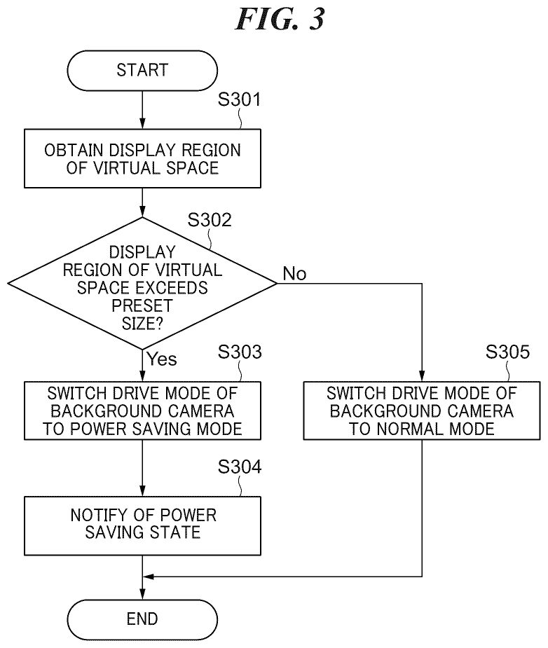

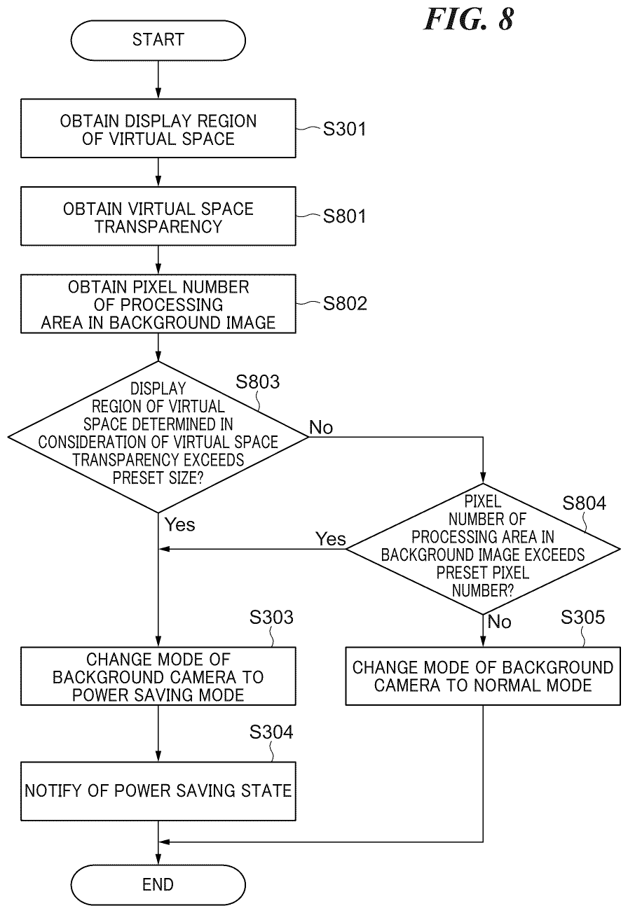

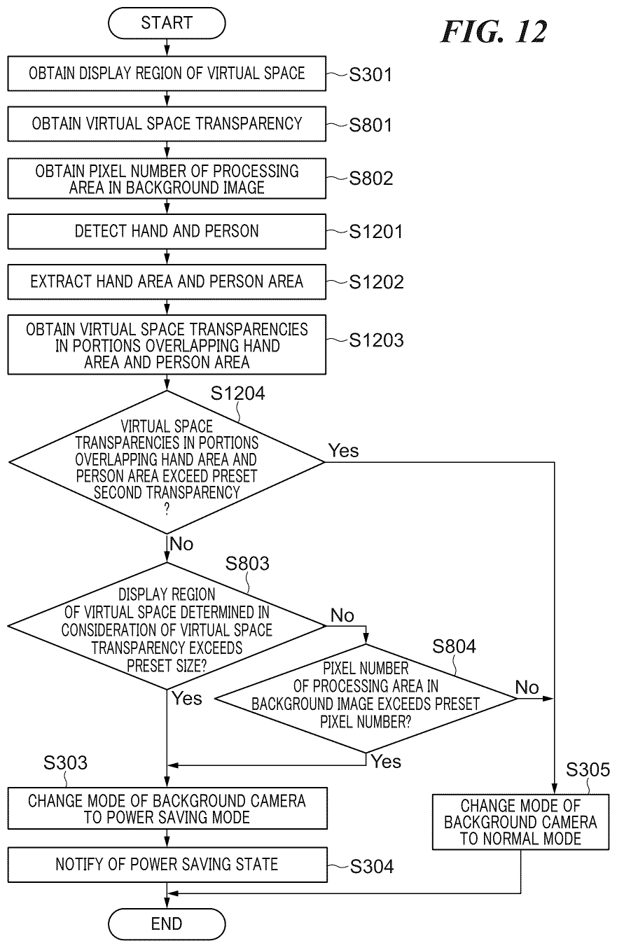

FIG. 3 is a flowchart illustrating a process performed when the drive mode of the background camera is switched in the first embodiment. The process of the flowchart in FIG. 3 (a control method for the information processing apparatus) is achieved by the CPU 101 (computer) reading program stored in the ROM 102, developing it on the RAM 103, and executing it. Note that the process of the flowchart in FIG. 3 may be executed for each frame of a real space image obtained by the background camera or may be executed periodically at specific time intervals. Further, the process of the flowchart in FIG. 3 may be executed with the change of the virtual space display region as a trigger. The same applies to processes of flowcharts in FIG. 8 and FIG. 12 described later.

When the process of the flowchart in FIG. 3 is started, the CPU 101 obtains in a step S301 the display region of the virtual space by the virtual space display region obtaining module 205 (a first obtaining step). In a step S302, the CPU 101 determines whether the size of the display region of the virtual space exceeds the preset size (a display region threshold) by the camera drive mode switchover module 206. When the CPU 101 determines by the camera drive mode switchover module 206 that the size of the display region of the virtual space exceeds the preset size, the process proceeds to a step S303. On the other hand, when the CPU 101 determines that the size of the display region of the virtual space does not exceed the preset size by the camera drive mode switchover module 206, the process proceeds to a step S305 described later. As described above, the CPU 101 can change the preset size in accordance with the user's instruction through the UI screen by the display region threshold setting module 207. The UI screen will be described in detail later.

In the step S303, the CPU 101 switches the drive mode of the background camera so that the background camera operates in the power saving mode by the camera drive mode switchover module 206 (a camera drive mode switchover step). In the power saving mode, the driving power of the background camera is reduced by reducing a frame rate or resolution of the background camera as compared with that in a normal mode described later. At this time, the camera drive mode switchover module 206 may gradually reduce the frame rate or the resolution of the background camera. The camera drive mode switchover module 206 may operate the background camera in a drive mode having other power saving effects, instead of lowering the functions such as the frame rate and the resolution of the background camera.

In addition, when the remaining power capacity obtained from the power control module 204 becomes equal to or less than a preset first capacity, the camera drive mode switchover module 206 may switch the drive mode of the background camera so that the background camera operates in the power saving mode. The camera drive mode switchover module 206 may reduce the preset size when the remaining power capacity obtained from the power control module 204 becomes equal to or less than a preset second capacity (preset capacity). In this way, when the remaining power capacity of the power supply that supplies the driving power to the background camera of the information processing apparatus 100 is reduced, the background camera is likely to transition to the power saving mode.

In a step S304, the CPU 101 notifies the user that the background camera is in the power saving state by the power saving notification module 208 and the display module 209. Thus, the user can know the reduction of the drive power of the background camera. Thereafter, the process of the flowchart in FIG. 3 ends. The notification to the user is performed by, for example, a pop-up or an icon displayed on the display unit 109. The pop-up and the icon will be described in detail later.

In a step S305, the CPU 101 switches the drive mode of the background camera by the camera drive mode switchover module 206 so that the background camera operates in the normal mode (the camera drive mode switchover step). At this time, the camera drive mode switchover module 206 returns the setting of the background camera changed at the time of transition to the power saving mode to the original setting. That is, in the normal mode, the driving power of the background camera is increased by increasing the frame rate or the resolution as compared with that in the power saving mode. At this time, the camera drive mode switchover module 206 may gradually increases the frame rate or the resolution of the background camera. In this way, the background camera captures a high quality real space image as a background image. Thereafter, the process of the flowchart in FIG. 3 ends.

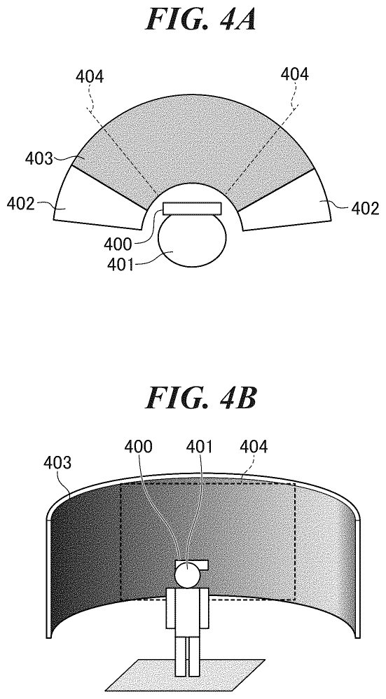

FIG. 4A and FIG. 4B are views for describing a relationship between a virtual space display region and switching of the drive mode of the background camera in the first embodiment. FIG. 4A is a view schematically illustrating a real space 402 and a virtual space 403 viewed by a user 401 wearing an HMD 400 in which the information processing apparatus 100 is incorporated, from a viewpoint overlooking from above the user 401. The user 401 wears the HMD 400 on a head and is viewing an MR image. The real space 402 appears to the user 401 as the background of the MR image. The virtual space 403 appears to the user 401 as a CG object in the MR image. A preset size 404 shown in FIG. 4A is an example.

In this case, as described above, the virtual space display region obtaining module 205 obtains the region of the three dimensional space occupied by the virtual space 403 as the display region of the virtual space. On the other hand, the region of the three dimensional space obtained by combining the virtual space 403 and the real space 402 occupies a large part of a visual field of the user 401. In this regard, the virtual space 403 is expanded so as to cover the visual field of the user 401. Thus, the region of the three dimensional space occupied by the virtual space 403 substantially occupies the visual field of the user 401. Therefore, the region in which the user 401 can see the real space 402 (that is, the background image of the MR) is narrowed.

In this way, when the region of the three dimensional space occupied by the virtual space 403, that is, the virtual space display region, is wide, even if the quality of the background image is lowered due to reduction of the frame rate or the resolution of the background camera, the influence on the user experience is small. Therefore, when determining that the size of the virtual space display region exceeds the preset size 404, the camera drive mode switchover module 206 switches the drive mode of the background camera so that the background camera operates in the power saving mode (the step S303). This reduces the power consumption of the HMD 400.

FIG. 4B is a view illustrating one specific display example of the virtual space 403 in FIG. 4A. In the case shown in FIG. 4B, the virtual space 403 is seen by the user 401 as a CG object of the MR image expanded so as to cover the visual field of the user 401. Furthermore, the display region of the CG object of the MR image, that is, the virtual space display region, exceeds the preset size 404. Therefore, the camera drive mode switchover module 206 switches the drive mode of the background camera so that the background camera operates in the power saving mode (the step S303). The virtual space 403 may be expanded so as to be seen as a plurality of CG objects of the MR image by the user 401. In FIG. 4B, the CG object is used as the specific display example of the virtual space 403, but a VR space or the like may be used.

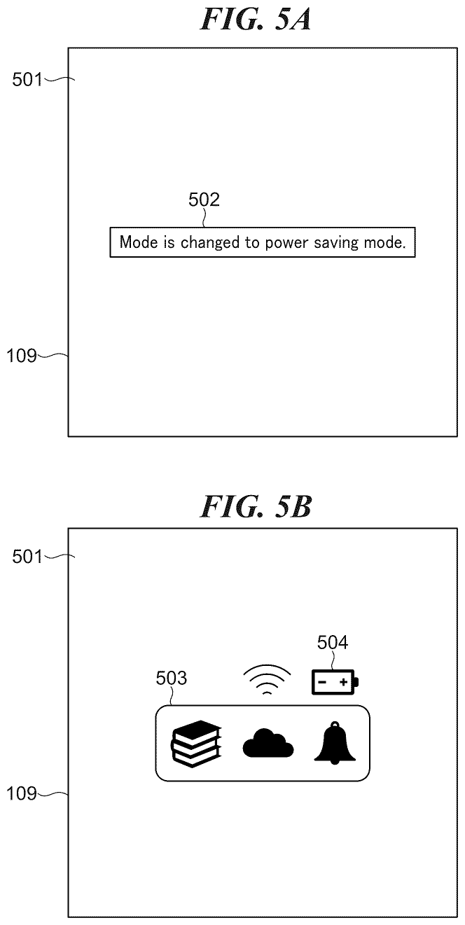

FIG. 5A and FIG. 5B are views illustrating a pop-up and icons for notifying the user 401 that the background camera is in the power saving state in the first embodiment. FIG. 5A is a view illustrating an example of a pop-up 502 indicating that the background camera transitions to the power saving mode. An MR image 501 is displayed on the display unit 109. The pop-up 502 indicates that the background camera transitions to the power saving mode. FIG. 5B is a view illustrating an example of an icon 504 indicating that the background camera is transitioning to the power saving mode. A pop-up 503 is configured by CG objects. The icon 504 is displayed above the pop-up 503. The power saving notification module 208 and the display module 209 display the pop-up 502 or the icon 504 so as to be superimposed on the MR image 501 when the switching of the drive mode of the background camera so that the background camera operates in the power saving mode as a trigger (the step S304).

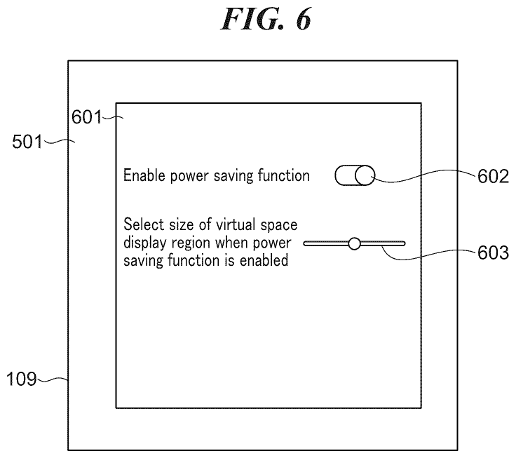

FIG. 6 is a view illustrating a UI screen 601 through which the user 401 instructs the setting change of the preset size 404 in the first embodiment. The UI screen 601 is displayed in a pop-up manner on the MR image 501 displayed on the display unit 109. The UI screen 601 includes a toggle switch 602 and a slider 603 as UIs formed by CG objects. The toggle switch 602 is used when the user 401 switches the power saving function of the background camera between enabled and disabled. The slider 603 is used when the user 401 selects the preset size 404. The user 401 can display the UI screen 601 in the pop-up manner using a control stick (not shown) provided in the HMD 400. Further, the user 401 can operate the toggle switch 602 and the slider 603 with the control stick in the HMD 400.

When the power saving function of the background camera is switched to be enabled with the toggle switch 602, the user 401 can select the preset size 404 with the slider 603. By such switching and selection operations, the user 401 instructs setting change of the preset size 404 on the UI screen 601. In response to this instruction, the display region threshold setting module 207 changes the setting of the preset size 404. At this time, the display region threshold setting module 207 changes the setting of the preset size 404, which is used for comparison with the size of the display region of the virtual space, to the size selected by the slider 603 on the UI screen 601. In this manner, the user 401 can cause the information processing apparatus 100 to reconfigure the preset size 404.

Here, when the preset size 404 is changed to be larger, the camera drive mode switchover module 206 can switch the drive mode of the background camera so that the background camera operates in the power saving mode while the virtual space 403 is displayed in a larger region on the display unit 109. In contrast, when the preset size 404 is changed to be smaller, the camera drive mode switchover module 206 can change the drive mode of the background camera so that the background camera operates in the power saving mode while the virtual space 403 is displayed in a smaller region on the display unit 109. The UI used when the user 401 selects the preset size 404 is not limited to the slider 603, and may be, for example, radio buttons that allow the user 401 to select one from choices such as “small”, “normal”, and “large”.

As described above, the information processing apparatus 100 of the first embodiment switches the drive mode of the background camera according to the region of the virtual space 403 currently displayed on the display unit 109, that is, the size of the virtual space display region, and thus it is possible to adaptively reduce the power consumption of the HMD 400.

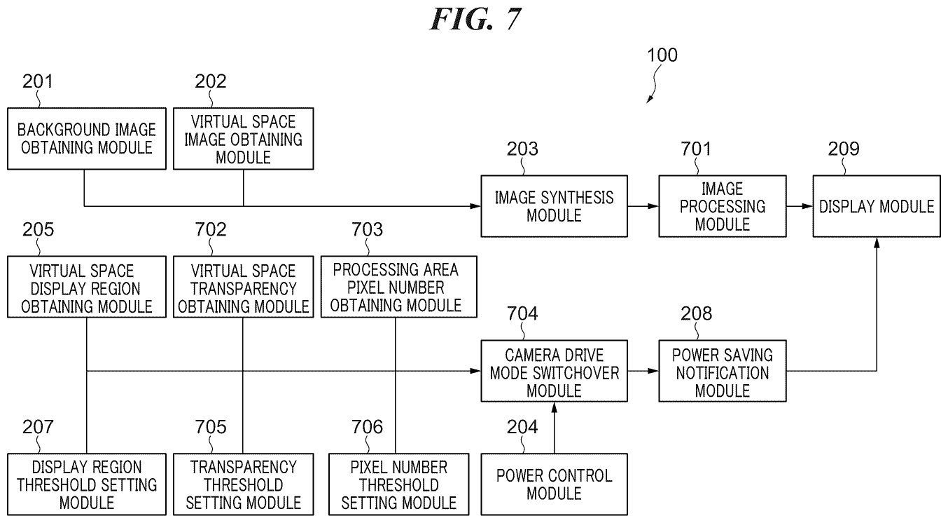

Hereinafter, a second embodiment will be described with reference to FIG. 7 to FIG. 10. In second embodiment, a method of determining whether the drive mode of the background camera needs to be switched using the virtual space display region obtained in consideration of a transparency of the virtual space will be described. In the second embodiment, the same configuration and process as those of the first embodiment are denoted by the same reference numerals, and the description thereof will be omitted. In the second embodiment, differences from the first embodiment will be described.

FIG. 7 is a block diagram illustrating an example of a software logical configuration of the information processing apparatus 100 of the second embodiment. An image processing module 701 applies an image process to a synthetic image obtained from the image synthesis module 203. The image process may be a blurring process to blur a region other than an attention region. A virtual space transparency obtaining module 702 (a second obtaining unit) obtains a transparency of the virtual space 403 (hereinafter referred to as a “virtual space transparency”). Note that, only the background image of the MR is displayed on the display unit 109 in a portion where the virtual space transparency is the maximum in the virtual space 403, and only the virtual space image of the MR (that is, the CG object) is displayed on the display unit 109 in a portion where the virtual space transparency is the minimum.

A processing area pixel number obtaining module 703 (a third obtaining unit) obtains the pixel number in a processing area of the background image. The pixel number in the processing area of the background image is the pixel number in an area where the user 401 is difficult to see details due to the image process that processes a part of the background image. The image process that processes a part of the background image may be the blurring process. The processing area pixel number obtaining module 703 may obtain the pixel number of the processing area of the background image from the area corresponding to the background image in the synthetic image subjected to the image process by the image processing module 701. The processing area pixel number acquisition unit 703 may acquire the pixel number of the processing area of the background image from the current display mode of the background image. The display mode of the background image is used to determine whether to apply any image process to the background image.

A camera drive mode switchover module 704 determines whether the drive mode of the background camera needs to be switched, using the virtual space display region obtained from the virtual space display region obtaining module 205 and the virtual space transparency obtained from the virtual space transparency obtaining module 702. At this time, unlike the first embodiment, a camera drive mode switchover module 704 sets a region in which the virtual space transparency is equal to or less than a preset first transparency (a first threshold, a transparency threshold value) in the range of the virtual space 403 currently displayed in display unit 109 as the virtual space display region. Then, when determining that the size of the virtual space display region exceeds the preset size, the camera drive mode switchover module 704 switches the drive mode of the background camera so that the background camera operates in the power saving mode.

Further, the camera drive mode switchover module 704 determines whether the drive mode of the background camera needs to be switched by using the pixel number of the processing area of the background image obtained from the processing area pixel number obtaining module 703. At this time, even when the size of the virtual space display region is equal to or less than the preset size, when the pixel number of the processing area of the background image exceeds a preset pixel number (a third threshold, a pixel number threshold), the camera drive mode switchover module 704 switches the drive mode of the background camera so that the background camera operates in the power saving mode. In contrast, when the size of the virtual space display region is equal to or less than preset size and the pixel number of the processing area of the background image is equal to or less than the preset pixel number, the camera drive mode switchover module 704 switches the drive mode of the background camera so that the background camera operates in the normal mode.

A transparency threshold setting module 705 (a first setting changing unit) changes a setting of a preset first transparency, which is compared with the virtual space transparency by the camera drive mode switchover module 704, in accordance with a user's instruction through the UI screen 601. A pixel number threshold setting module 706 (a third setting changing unit) changes the setting of the preset pixel number, which is compared with the pixel number of the processing area of the background image by the camera drive mode switchover module 704, in accordance with a user's instruction through the UI screen 601.

FIG. 8 is a flowchart illustrating a process performed when a drive mode of a background camera is switched in the second embodiment. In a step S801, the CPU 101 obtains the virtual space transparency by the virtual space transparency obtaining module 702. At this time, the virtual space transparency obtaining module 702 may obtain the virtual space transparency from the transparency designated in the region of the virtual space 403 currently displayed on the display unit 109. The virtual space transparency obtaining module 702 may obtain the virtual space transparency from the opacity set for the virtual space image. In this case, the virtual space transparency obtaining module 702 obtains the virtual space transparency by inverting the opacity. Further, the virtual space transparency obtaining module 702 may obtain the virtual space transparency from the virtual space image if possible. In a step S802, the CPU 101 obtains the pixel number of the processing area of the background image by the processing area pixel number obtaining module 703.

In a step S803, the CPU 101 determines whether the size of the display region of the virtual space exceeds the preset size 404 by the camera drive mode switchover module 704. However, as described above, the virtual space display region is a region in which the virtual space transparency is equal to or less than the preset first transparency in the region of the virtual space 403 currently displayed on the display unit 109. That is, in the step S803, the virtual space display region determined in consideration of the virtual space transparency is compared with the preset size 404. When the CPU 101 determines by the camera drive mode switchover module 704 that the size of the virtual spatial display region exceeds the preset size, the process proceeds to the step S303. On the other hand, when the CPU 101 determines that the size of the virtual space display region does not exceed the preset size by the camera drive mode switchover module 704, the process proceeds to a step S804. As described above, the CPU 101 can change the setting of the preset first transparency in accordance with a user's instruction through the UI screen 601 by the transparency threshold setting module 705. This point will be described in detail later.

In a step S804, the CPU 101 determines whether the pixel number in the processing area of the background image exceeds the preset pixel number by the camera drive mode switchover module 704. When the CPU 101 determines by the camera drive mode switchover module 704 that the pixel number in the processing area of the background image exceeds the preset pixel number, the process proceeds to the step S303. On the other hand, when the CPU 101 determines by the camera drive mode switchover module 704 that the pixel number in the processing area of the background image does not exceed the preset pixel number, the process proceeds to the step S305. As described above, the CPU 101 can change the setting of the preset pixel number in accordance with a user's instruction through the UI screen 601 by the pixel number threshold setting module 706. This point will be described in detail later.

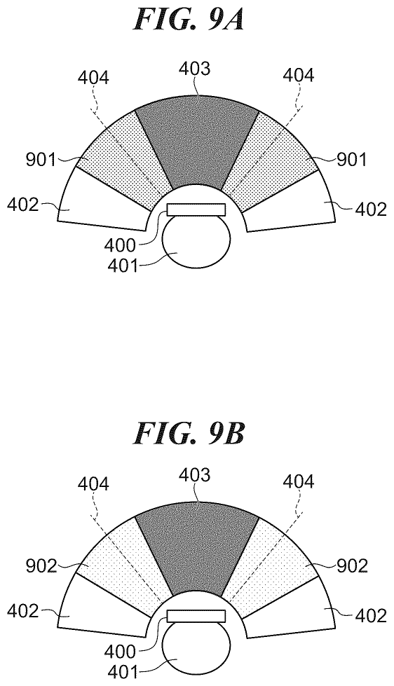

FIG. 9A and FIG. 9B are views for describing a relationship between a virtual space display range and switching of the drive mode of the background camera in the second embodiment. FIG. 9A is a view illustrating a virtual space display region when the background camera of the information processing apparatus 100 incorporated in the HMD 400 worn by the user 401 transitions to the power saving mode, from a viewpoint overlooking from above the user 401. A portion 901 of the virtual space 403 is at the boundary with the real space 402.

In the portion 901 of the virtual space 403, the real space 402 is displayed through the virtual space 403. However, since the virtual space transparency of the portion 901 of the virtual space 403 is smaller than the preset first transparency, the display ratio in the virtual space 403 is higher than the display ratio in the real space 402 serving as the background of the MR image 501. Therefore, even if the quality of the background image in the portion 901 of the virtual space 403 is lowered due to reduction of the frame rate or the resolution of the background camera, the influence on the user experience is small. Therefore, as illustrated in FIG. 9A, when the size of the virtual space 403 including the portion 901 exceeds the preset size 404, the camera drive mode switchover module 206 switches the drive mode of the background camera so that the background camera operates in the power saving mode (the step S303). This reduces the power consumption of the HMD 400.

FIG. 9B is a view illustrating the virtual space display region when the background camera of the information processing apparatus 100 incorporated in the HMD 400 worn by the user 401 transitions to the normal mode, from a viewpoint overlooking from above the user 401. A portion 902 of the virtual space 403 is at the boundary with the real space 402. In the portion 902 of the virtual space 403, the real space 402 is displayed through the virtual space 403. However, since the virtual space transparency in the portion 902 of the virtual space 403 is larger than the preset first transparency, the display ratio of the real space 402 serving as the background of the MR image 501 is higher than the display ratio of the virtual space 403. Therefore, when the quality of the background image in the portion 902 of the virtual space 403 is lowered due to reduction of the frame rate or the resolution of the background camera, the influence on the user experience is great. Therefore, as illustrated in FIG. 9B, when the size of the virtual space 403 excluding the portion 902 does not exceed the preset size 404, the camera drive mode switchover module 206 switches the drive mode of the background camera so that the background camera operates in the normal mode (the step S305).

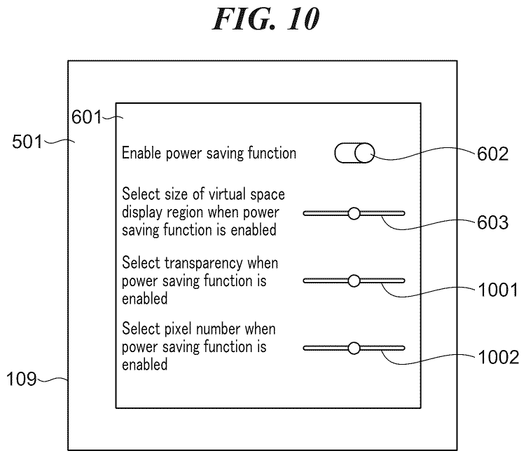

FIG. 10 is a view illustrating the UI screen 601 through which the user 401 instructs the setting change of the preset first transparency (the transparency threshold) and the setting change of the preset pixel number (a pixel number threshold) in the second embodiment. The UI screen 601 includes sliders 1001 and 1002 in addition to the toggle switch 602 and the slider 603 described above as UIs configured by CG objects. The slider 1001 is a UI used when the user 401 selects the preset first transparency. The slider 1002 is a UI used when the user 401 selects the preset pixel number. The user 401 can operate the sliders 1001 and 1002 with the control stick in the HMD 400.

When the power saving function of the background camera is switched to be enabled with the toggle switch 602, the user 401 can select the preset first transparency with the slider 1001 and can select the preset pixel number with the slider 1002. By such switching and selection operations, the user 401 instructs the setting change of the preset first transparency and the setting change of the preset pixel number through the UI screen 601. In response to the instructions, the transparency threshold setting module 705 changes the setting of the preset first transparency and the pixel number threshold setting module 706 changes the setting of the preset pixel number. At this time, the transparency threshold setting module 705 changes the setting of the preset first transparency used for comparison with the virtual space transparency to the transparency selected with the slider 1001 on the UI screen 601. The pixel number threshold setting module 706 changes the setting of the preset pixel number used for comparison with the pixel number of the processing area in the background image to the pixel number selected by the slider 1001 on the UI screen 601. In this manner, the user 401 can cause the information processing apparatus 100 to change the setting of the preset first transparency and the preset pixel number.

Here, when the size of the virtual space display region used in the determination in the step S803 becomes larger by changing the setting of the preset first transparency to be larger, the background camera is more likely to transition to the power saving mode. In addition, when the setting of the preset pixel number is changed to be smaller, the preset pixel number used in the determination in the step S804 is also smaller, and thus the background camera is more likely to transition to the power saving mode.

As described above, the information processing apparatus 100 of the second embodiment can more adaptively reduce the power consumption of the HMD 400 by switching the drive mode of the background camera according to the size of the virtual space display region obtained in consideration of the virtual space transparency. Further, when the size of the virtual space display region obtained in consideration of the virtual space transparency does not exceed the preset size, the information processing apparatus 100 of the second embodiment switches the drive mode of the background camera according to the pixel number in the processing area of the background image. Accordingly, the information processing apparatus 100 of the second embodiment can further adaptively reduce the power consumption of the HMD 400.

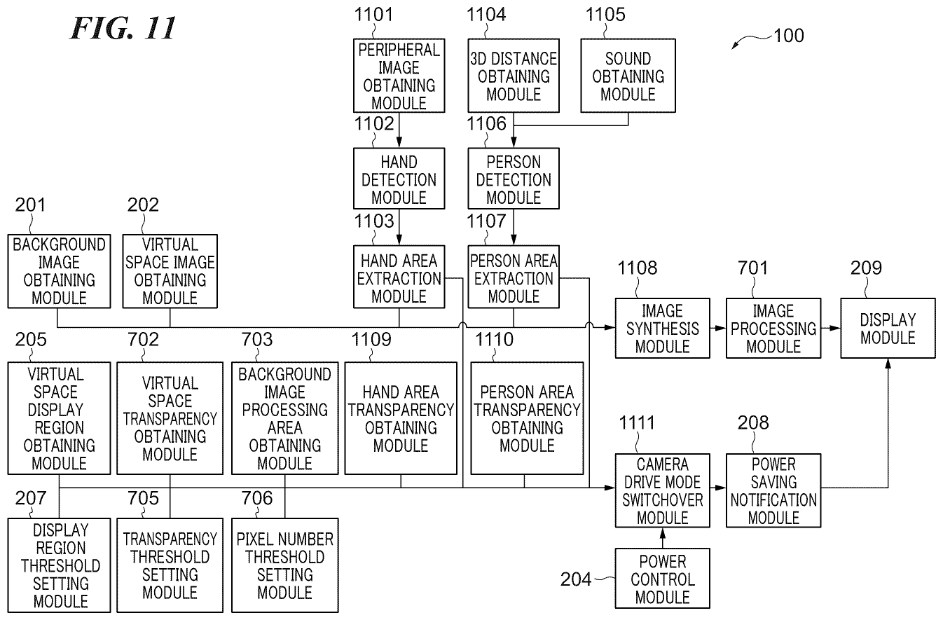

Hereinafter, a third embodiment will be described with reference to FIG. 11 to FIG. 14. In the third embodiment, a method of determining whether the drive mode of the background camera needs to be switched in consideration of a detection result of a hand of the user 401 and a detection result of a person other than user 401 will be described. In the third embodiment, the same configuration and process as those of the second embodiment are denoted by the same reference numerals, and the description thereof will be omitted. In the third embodiment, differences from the second embodiment will be described.

FIG. 11 is a block diagram illustrating an example of a software logical configuration of an information processing apparatus 100 of the third embodiment. A peripheral image obtaining module 1101 obtains an image for estimating a position and an orientation of a hand of the user 401 from the position camera by capturing a periphery of the user 401 with the position camera of the image capturing unit 106. A hand detection module 1102 detects a hand from the image obtained from the peripheral image obtaining module 1101. A hand area extraction module 1103 (a first extraction unit) extracts an image area of the hand (a hand area) in the background image using the detection result of the hand obtained from the hand detection module 1102.

A 3D (three dimensional) distance obtaining module 1104 obtains a 3D distance image of the real space 402 from the distance sensor 107. A sound obtaining module 1105 obtains sound around the information processing apparatus 100, that is, sound around the user 401 wearing the HMD 400, from the microphone 108. A person detection module 1106 detects a person within a preset distance from the distance sensor 107, that is, a person within the preset distance from the user 401 wearing the HMD 400, from the 3D distance image obtained from the 3D distance obtaining module 1104. At this time, the person detection module 1106 may detect a person who is speaking to the user 401 by narrowing down persons who are within the preset distance from the distance sensor 107 in consideration of sound obtained from the sound obtaining module 1105. A person area extraction module 1107 (a second extraction unit) extracts an image area of the person (a person area) in the background image using the detection result of the person obtained from the person detection module 1106.

An image synthesis module 1108 synthesizes the background image and the virtual space image in consideration of the hand area obtained from the hand area extraction module 1103 and the person area obtained from the person area extraction module 1107, and obtains a synthetic image. At this time, the image synthesis module 1108 may synthesize the images so that the hand and the person in the background image are clearly displayed by maximizing the virtual space transparency of the portions of the virtual space 403 overlapping the hand area and the person area. A hand area transparency obtaining module 1109 (a fourth obtaining unit) obtains a virtual space transparency of a portion of the virtual space 403 overlapping the hand area (a transparency of the portion of the virtual space). A person area transparency obtaining module 1110 (a fifth obtaining unit) obtains a virtual space transparency of a portion of the virtual space 403 overlapping the person area (a transparency of the portion of the virtual space).

A camera drive mode switchover module 1111 is different from the camera drive mode switchover module 704 in the following points. The camera drive mode switchover module 1111 determines whether the drive mode of the background camera needs to be switched using the virtual space transparency of the portion of the virtual space 403 overlapping the hand area or the person area obtained from the hand area transparency obtaining module 1109 or the person area transparency obtaining module 1110. At this time, when the virtual space transparencies of the portions of the virtual space 403 overlapping the hand area and the person area exceed preset second transparency (a fourth threshold and a fifth threshold), the camera drive mode switchover module 1111 switches the drive mode of the background camera so that the background camera operates in the normal mode. In contrast, when the virtual space transparencies of the portions of the virtual space 403 overlapping the hand area and the person area do not exceed the second transparency, the camera drive mode switchover module 1111 switches the drive mode of the background camera according to the size of the virtual space display region and the pixel number of the processing area of the background image.

FIG. 12 is a flowchart illustrating a process performed when a drive mode of a background camera is switched in the third embodiment. In a step S1201, the CPU 101 detects a hand and a person by using the hand detection module 1102 and the person detection module 1106. In a step S1202, the CPU 101 extracts the hand area and the person area by the hand area extraction module 1103 and the person area extraction module 1107. In a step S1203, the CPU 101 obtains the virtual space transparency of the portion of the virtual space 403 that overlaps the hand area by the hand area transparency obtaining module 1109. Further, the CPU 101 obtains the virtual space transparency of the portion of the virtual space 403 overlapping the person area by the person area transparency obtaining module 1110.

In a step S1204, the CPU 101 determines whether the virtual space transparencies of the portions of the virtual space 403 that overlap the image areas of the hand and the person exceed the preset second transparency by the camera drive mode switchover module 1111. When the CPU 101 determines that the virtual space transparency of the portion of the virtual space 403 that overlaps the hand area exceeds the preset second transparency by the camera drive mode switchover module 1111, the process proceeds to the step S305. Similarly, when the CPU 101 determines that the virtual space transparency of the portion of the virtual space 403 that overlaps the person area exceeds the preset second transparency, the processing proceeds to the step S305. In contrast, when the CPU 101 determines that the following conditions (1) and (2) are satisfied by the camera drive mode switchover module 1111, the process proceeds to the step S803.
(1) The virtual space transparency of the portion of the virtual space 403 overlapping the hand area does not exceed the preset second transparency.
(2) The virtual space transparency of the portion of the virtual space 403 overlapping the person area does not exceed the preset second transparency.

The CPU 101 (a fourth setting changing unit, a fifth setting changing unit) may change the setting of the preset second transparency in accordance with a user's instruction through the UI screen 601, similarly to the change of the setting of the preset first transparency described above. Further, the preset second transparency compared with the virtual space transparency of the portion of the virtual space 403 overlapping the hand area may be different from the preset second transparency compared with the virtual space transparency of the portion of the virtual space 403 overlapping the person area.

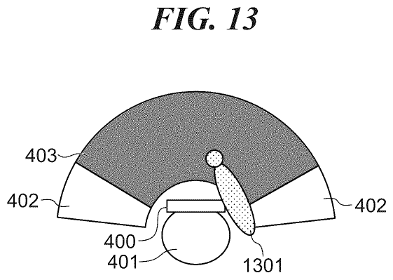

FIG. 13 is a view illustrating a situation in which a hand 1301 of the user 401 overlaps the virtual space 403 in a case where the background camera operates in the power saving mode in the third embodiment, from a viewpoint of looking down from above the user 401. Hereinafter, a relationship between the virtual space transparency of the portion of the virtual space 403 overlapping the image area of the hand 1301 of the user 401 (the hand area) and the switching of the drive mode of the background camera will be described using FIG. 13. When the virtual space transparency of the portion of the virtual space 403 overlapping the image area of the hand 1301 of the user 401 exceeds the preset second transparency, the camera drive mode switchover module 1111 switches the drive mode of the background camera so that the background camera operates in the normal mode (the step S305). In this manner, when the virtual space transparency of the portion of the virtual space 403 overlapping the image area of the hand 1301 of the user 401 of the background image is large, the image region of the hand 1301 of the user 401 of the background image is clearly displayed in the MR image 501.

On the other hand, when the virtual space transparency of the portion of the virtual space 403 overlapping the image area of the hand 1301 of the user 401 of the background image is small, the image area of the hand 1301 of the user 401 of the background image does not need to be clearly displayed in the MR image 501. Therefore, when the conditions (1) and (2) described above are satisfied (NO in the step S1204), the camera drive mode switchover module 1111 does not switch the drive mode of the background camera. Further, when the size of the virtual space display region exceeds the preset size or when the pixel number of the processing area of the background image exceeds the preset pixel number, the camera drive mode switchover module 1111 causes the background camera to operate in the power saving mode (the step S303). In this manner, the image area of the hand 1301 of the user 401 of the degraded background image is blended with the virtual space 403 and displayed in the MR image 501, and thus the power consumption of the HMD 400 is reduced.

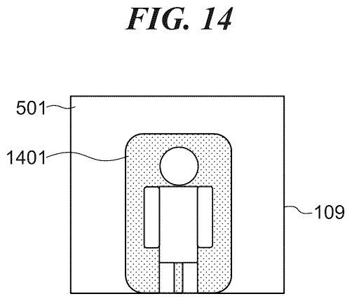

FIG. 14 is a view illustrating one of specific display examples of a person other than the user 401 in the third embodiment. There is an image area 1401 of the person (a person area) in the background image. In the MR image 501, the virtual space 403 is displayed except for the image area 1401 of the person. Hereinafter, a relationship between the virtual space transparency of the portion of the virtual space 403 overlapping the image area 1401 of the person other than the user 401 and the switching of the drive mode of the background camera will be described using FIG. 14. When the virtual space transparency of the portion of the virtual space 403 that overlaps the image area 1401 of the person exceeds the preset second transparency, the camera drive mode switchover module 1111 switches the drive mode of the background camera so that the background camera operates in the normal mode (the step S305). In this way, when the virtual space transparency of the portion of the virtual space 403 overlapping the image area 1401 of the person in the background image is large, the image area 1401 of the person in the background image is clearly displayed in the MR image 501.

On the other hand, when the virtual space transparency of the portion of the virtual space 403 overlapping the image area 1401 of the person in the background image is small, the image area 1401 of the person in the background image does not need to be clearly displayed in the MR image 501. Therefore, when the conditions (1) and (2) described above are satisfied (NO in the step S1204), the camera drive mode switchover module 1111 does not switch the drive mode of the background camera. Further, when the size of the virtual space display region exceeds the preset size or when the pixel number of the processing area of the background image exceeds the preset pixel number, the camera drive mode switchover module 1111 causes the background camera to operate in the power saving mode (the step S303). In this way, since the image area 1401 of the person in the degraded background image is blended with the virtual space 403 and displayed, the power consumption of the HMD 400 is reduced.

As described above, when the virtual space transparency of the portion of the virtual space 403 overlapping the image area of the hand 1301 of the user 401 exceeds the preset second transparency, the information processing apparatus 100 of the third embodiment switches the drive mode of the background camera so that the background camera operates in the normal mode. As a result, the hand 1301 of the user 401 in the real space 402 is clearly displayed through the virtual space 403 in the MR image 501. In addition, when the virtual space transparency of the portion of the virtual space 403 overlapping the image area 1401 of the person within the preset distance from the user 401 exceeds the preset second transparency, the information processing apparatus 100 switches the drive mode of the background camera so that the background camera operates in the normal mode. As a result, the person who is within the preset distance from the user 401 in the real space 402 is clearly displayed through the virtual space 403 in the MR image 501.

Although the embodiments of the present disclosure have been described above, the present disclosure is not limited to the above described embodiments, and various modifications and changes can be made within the scope of the gist thereof. For example, the CPU 101 may change the quality of the background of the MR image 501 in which the UI screen 601 is popped up in accordance with the size selected with the slider 603. The CPU 101 may display a window displaying the background of the MR image 501 whose quality changes in accordance with the size selected with the slider 603 on the UI screen 601 in an overlapping manner. The same applies to the transparency selected with the slider 1001 and the pixel number selected with the slider 1002.

In addition, when the size of the virtual space display region exceeds the preset size, the CPU 101 may display a switch button on the display unit 109, and when the switch button is operated by the user 401, the process may proceed to the step S303. This point is the same as in a case where the pixel number of the processing area of the background image exceeds the preset pixel number.

The CPU 101 may change the setting of the preset first capacity and the setting of the preset second capacity in accordance with a user's instruction through the UI screen 601, similarly to the change of the setting of the preset size. At this time, when the setting of the preset first capacity or the preset second capacity is changed, the CPU 101 may notify the user of the change by a method of displaying a pop-up or an icon by the display module 209, lighting, blinking, or sound. These points are also the same for the preset distance used by the person detection module 1106.

Each embodiment is an example in which the present disclosure is applied to the MR. However, the present disclosure is not limited thereto, and can also be applied to, for example, an AR (Augmented Reality).

According to the present disclosure, it is possible to adaptively reduce a power consumption.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-153864, filed Sep. 6, 2024 which is hereby incorporated by reference herein in its entirety.

What is claimed is:

1. An information processing apparatus comprising:
a memory device that stores a set of instructions; and
at least one processor that executes the set of instructions to:
obtain a region of a virtual space to be displayed on a display unit in a manner superimposed on a real space captured by a first camera as a display region; and
switch a drive mode of the first camera according to a size of the display region.

2. The information processing apparatus according to claim 1, wherein the at
least one processor executes the set of instructions to:
obtain a transparency of the virtual space; and
set a size of a region in which the transparency of the virtual space is equal to or less than a first threshold in the display region as the size of the display region.

3. The information processing apparatus according to claim 2, wherein the at least one processor executes the set of instructions to allow a user to change a setting of the first threshold on a UI screen.

4. The information processing apparatus according to claim 1, wherein the at least one processor executes the set of instructions to switch the drive mode of the first camera so as to reduce a power consumption of the first camera in a case where the size of the display region exceeds a second threshold.

5. The information processing apparatus according to claim 4, wherein the at least one processor executes the set of instructions to switch the drive mode of the first camera so that the first camera captures a high quality image in a case where the size of the display region does not exceed the second threshold.

6. The information processing apparatus according to claim 5, wherein the at least one processor executes the set of instructions to:
obtain a pixel number of an area in which an image is processed in an image of the real space captured by the first camera; and
switch the drive mode of the first camera according to the size of the display region and the pixel number.

7. The information processing apparatus according to claim 6, wherein the at least one processor executes the set of instructions to switch the drive mode of the first camera so as to reduce the power consumption of the first camera in a case where the pixel number exceeds a third threshold even in a case where the size of the display region does not exceed the second threshold.

8. The information processing apparatus according to claim 7, wherein the at least one processor executes the set of instructions to switch the drive mode of the first camera so that the first camera captures a high quality image in a case where the pixel number does not exceed the third threshold and the size of the display region does not exceed the second threshold.

9. The information processing apparatus according to claim 4, wherein the at least one processor executes the set of instructions to reduce the second threshold in a case where a remaining power capacity of a power supply supplying driving power to the first camera is equal to or less than a preset capacity.

10. The information processing apparatus according to claim 1, wherein the at least one processor executes the set of instructions to:
obtain a transparency of a portion of the virtual space displayed on the display unit overlapping an image area of a hand of a user in the real space captured by the first camera; and
switch the drive mode of the first camera so that the first camera captures a high quality image in a case where the transparency of the portion of the virtual space exceeds a fourth threshold.

11. The information processing apparatus according to claim 10, wherein the at least one processor executes the set of instructions to:
detect the hand from an image around the user captured by a second camera; and
extract the image area of the hand from the image of the real space captured by the first camera using a detection result of the hand.

12. The information processing apparatus according to claim 1, wherein the at least one processor executes the set of instructions to:
obtain a transparency of a portion of a virtual space displayed on the display unit overlapping an image area of a person within a preset distance from a user in a real space captured by the first camera; and
switch the drive mode of the first camera so that the first camera captures a high quality image in a case where the transparency of the portion of the virtual space exceeds a fifth threshold.

13. The information processing apparatus according to claim 12, wherein the at least one processor executes the set of instructions to:
detect the person from a three dimensional distance image of a real space captured by a third camera; and
extract the image area of the person from the image of the real space captured by the first camera using the detection result of the person.

14. The information processing apparatus according to claim 13, wherein the at least one processor executes the set of instructions to detect a person who is speaking to the user in consideration of sound obtained from a microphone.

15. The information processing apparatus according to claim 1, wherein the at least one processor executes the set of instructions to notify a user of a reduction in a power consumption of the first camera in a case where the drive mode of the first camera is switched so that the power consumption of the first camera is reduced.

16. The information processing apparatus according to claim 1, wherein the at least one processor executes the set of instructions to obtain the display region from the current display mode of the image of the virtual space.

17. The information processing apparatus according to claim 1, wherein the at least one processor executes the set of instructions to obtain the display region from an opaque region of the image of the virtual space.

18. The information processing apparatus according to claim 1, wherein the information processing apparatus is a head mounted display including the first camera and the display unit.

19. A control method for an information processing apparatus, the control method comprising:
obtaining a region of a virtual space to be displayed on a display unit in a manner superimposed on a real space captured by a first camera as a display region; and
switching a drive mode of the first camera according to a size of the display region.

20. A non-transitory computer-readable storage medium storing a control program causing a computer to execute a control method for an information processing apparatus, the control method comprising:
obtaining a region of a virtual space to be displayed on a display unit in a manner superimposed on a real space captured by a first camera as a display region; and
switching a drive mode of the first camera according to a size of the display region.
